(19) United States
(12) Patent Application Publication
(10) Pub. No.: US 2019/0181595 A1
(43) Pub. Date: Jun. 13, 2019

(54) SUPPORT LIGHTING FOR ELECTRICAL POWER SYSTEMS

(71) Applicant: Darrin Jensen, Dodge Center, MN (US)

(72) Inventor: Darrin Jensen, Dodge Center, MN (US)

(21) Appl. No.: 16/275,309

(22) Filed: Feb. 13, 2019

Related U.S. Application Data
(63) Continuation-in-part of application No. 15/676,490, filed on Aug. 14, 2017.

(51) Int. Cl. H01R 13/717; F21S 9/02; F21V 23/04; F21V 15/01

(52) U.S. Cl. CPC H01R 13/7175; F21S 9/02; F21Y 2115/10; F21V 15/01; F21V 23/04

(57) ABSTRACT

A lighting system is incorporated into the ends of the electrical power cords to provide light when working in dark environments. The lighting source is preferably battery-operated, thus allowing the user to find power receptacles when in these dark environments. Additionally, a second power source is included in the plug receptacle end, which can be battery-powered or can be powered by electrical power carried within the power lines.

### BACKGROUND

When working at night, or in dark spaces, it is often difficult to locate items or necessary resources. In one particular example, when working in a location with very limited lighting, whether a darkened room or an outdoor location at night, it is typically very difficult to find electrical receptacles when needed. This is especially troublesome when attempting to find need power, which then can be used for lighting and/or necessary tools. In most cases, these situations require the use of a flashlight or some external lighting source. That said, this is often inconvenient since the flashlight may not be nearby or conveniently located. Additionally, this requires the handling of the flashlight, in addition to a cord and other tools that are being carried.

In these cases, it would be particularly beneficial if lighting components were convenient and available when handing the electrical power cords themselves, so that outlets and power sources could be easily located. Clearly, electrical lighting systems do not solve this problem, since the user is searching for a power source in the first place. Obviously, once power is located and sufficiently supplied, electrical spotlights, work lights, etc. can then be utilized. That said, this often requires use of additional components. More specifically, a work light or spotlight must be located and attached to a receptacle end of the cord. An integrated system would be beneficial, thus avoiding the need for additional components.

### SUMMARY

In order to provide a useful tool for locating electrical power sources, a battery-operated lighting source is incorporated into the plug portion of the electrical cord. The battery-operated lighting system is relatively small and self-contained within the plug housing, thus avoiding obstructions with other components and/or other plugs. Further, the battery-operated lighting system is easily operable using a control button located on an outer surface of the plug housing. To provide further utility, this battery operated lighting system is incorporated at the plug-in end of an extension cord, which can then supply power to remote locations. In the extension cord embodiment, the receptacle end may also include a lighting system for use in further illuminating various locations. This lighting system in the receptacle end could be battery operated, or alternatively powered by the electrical power carried within the cord. Again, this receptacle end power lighting system would be easily operated using control buttons located on an outer surface of the receptacle housing.

In addition to the battery operated light being incorporated into one end, the utility of the lighting system is further enhanced by having lighting systems at both ends of an electrical cord. In those situations where an outlet has been located and power is being provided to the cord, additional lighting needs often exist. To address this need, a small light is incorporated into the receptacle end of the cord for use in further locating items. Once power is supplied to the cord, this power is used to supply a switchable light source. To allow easy identification, the switch is illuminated (i.e. a switch button at the receptacle end is illuminated) and a receptacle end light source can be operated to locate items and/or become familiar with the surrounding. This provides an immediate tool for the user, without the need for additional components.

### BRIEF DESCRIPTION OF THE DRAWINGS

Further objects and advantages of the present invention can be seen from reading the following detailed description, in conjunction with the drawings in which:

FIG. 1 is a perspective view of the lighting system as embodied in an extension cord;

FIG. 2 is a close-up view of the plug-in end of an electrical power cord;

FIG. 3 is a close-up view of the receptacle end of an electrical power cord;

FIGS. 4A and 4B are a top view and an end view, respectively, of the plug-in end;

FIG. 5 is a partial cross-sectional schematic view of the plug-in end of an electrical power cord;

FIGS. 6A and 6B are a top view and end view, respectively, of the receptacle end of an electrical power cord; and

FIG. 7 is a partial cross-sectional schematic view of the receptacle end.

### DESCRIPTION

The disclosed lighting system can be incorporated in multiple electrical systems and/or electrical devices. In one particular embodiment, the incorporation of lighting features into an extension cord is outlined and discussed below. Those skilled in the art will recognize that the same features and advantages can be implemented in multiple devices. The following description is intended to describe the features and advantages of the present invention, and is not intended to be limiting in any way.

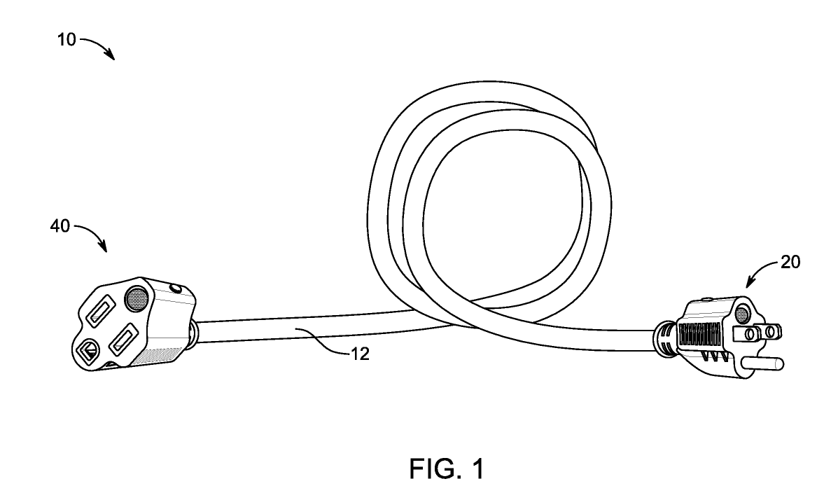

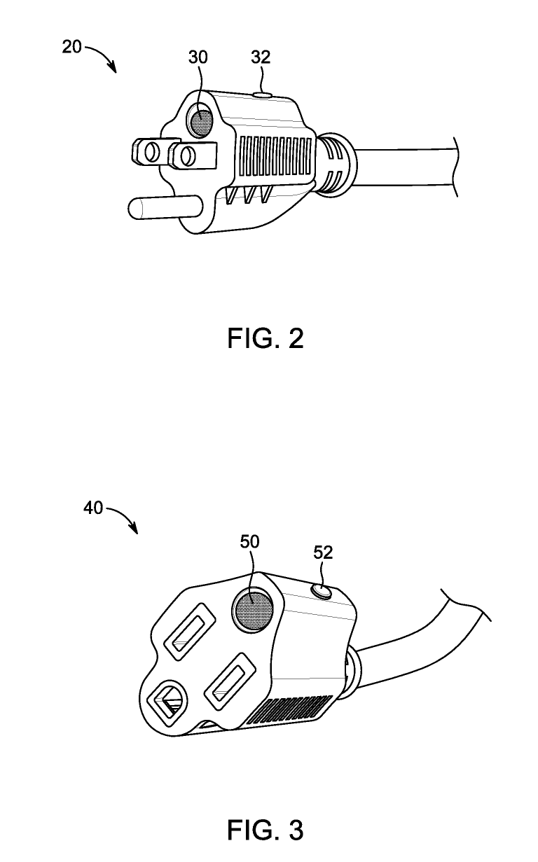

Referring now to FIG. 1, an embodiment of an extension cord 10 is illustrated. As will be recognized, extension cord 10 includes a plug-in end 20, a receptacle end 40 and an electrical cord 12. Plug-in end 20 and receptacle end 40 are both physically and electrically connected to one another via cord 12. Similarly, FIG. 2 shows a close-up view of plug-in end 20 while FIG. 3 illustrates a close-up view of receptacle end 40. As is well recognized, the extension cord is used in many different situations/settings. Some of these situations include use of the extension cord in rugged, dirty, and/or rough settings. As such, it is essential that the extension cord be rugged and capable of withstanding tough conditions. This includes significant levels of insulation and protection for the electrical element itself. It is contemplated that the structures outlined below would also have these characteristics and be capable of operating in these tough environments.

As part of the operating environments generally mentioned above, it should be recognized that the extension cords will be dragged, dropped and/or pulled across many different surfaces. Additionally, the size of plug-in end 20 and receptacle end 40 are important. It may be necessary to pull the extension cord through an opening, or place in a tight area. Thus, the plug-in end 20 and receptacle end 40 should be kept as small as possible. As shown in FIGS. 2 and 3, the lighting structure positioned within a ridge on an upper side of the housings (22 and 42, discussed in further detail below) does not significantly increase the size of these structures.

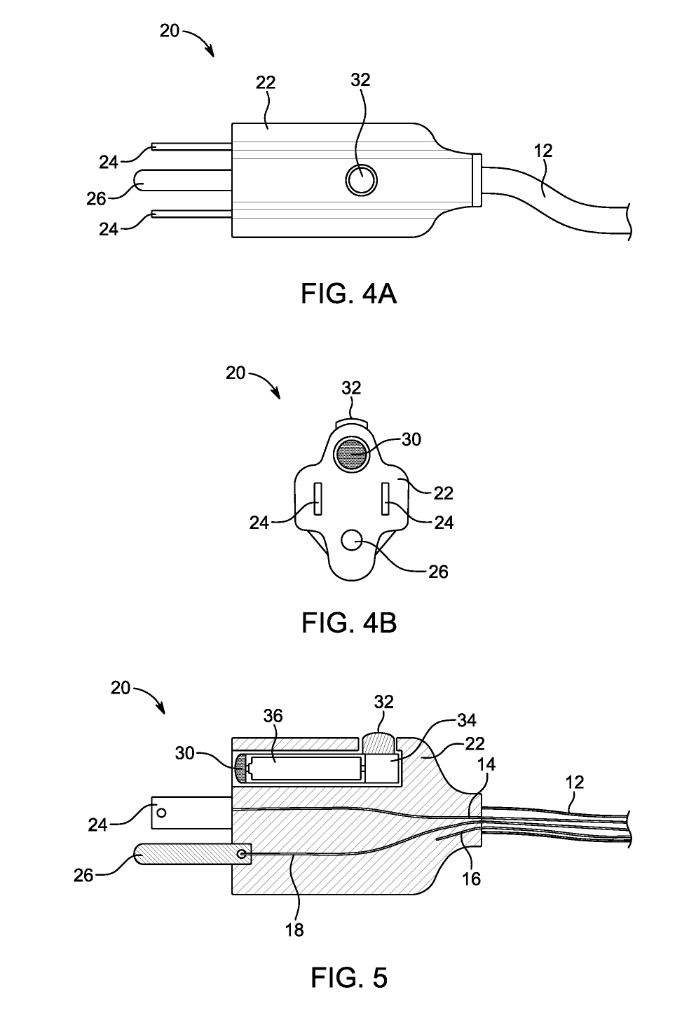

Referring now more specifically to FIGS. 4A and 4B, the plug-in end 20 is illustrated in further detail. More specifically, FIG. 4A shows a top view of plug-in end 20 while FIG. 4B shows a front view thereof. As seen, plug-in end 20 includes a housing 22 with electrical prongs 24 and a ground prong 26 extending from one end thereof. As will be recognized, this is the classical American three-prong electrical plug. Those skilled in the art will recognize that the configuration of plugs can vary, depending upon the specific need and international requirement involved. As also illustrated, a lighting system switch 32 is located on an upper side of housing 22. Further, a lightbulb 30 is positioned within housing 22, and is aimed or directed generally in the same direction as prongs 24 and 26. As will be further discussed below in relation to FIG. 5, lightbulb 30 is part of a battery-operated lighting system contained within housing 22, and which is operable using button 32. It is contemplated that button 32 will be a press-and-hold button, so that the light is “on” only when the button is being held down. This helps to preserve battery power, and is most practical since lighting from this end of the cord is often needed for only a short period of time. That said, alternatives are possible, including a “click-on/click-off” type button.

To further illustrate the internal workings of plug-in end 20, FIG. 5 illustrates a schematic cross-sectional view of this component. As previously mentioned, housing 22 contains lightbulb 30, and accommodates switch 32. Housing 22 will also include appropriate electrical connections or wires 14, 16, 18, to provide electrical power down cord 12. As recognized, these electrical connections are coupled to prongs 24 and ground prong 26. Also illustrated in FIG. 5 is switch 32, which is coupled to an electrical switching mechanism 34, and which will provide controlled connections so that power to and from a battery 36 is provided to lightbulb 30. While multiple switching mechanisms are possible, this approach provides a relatively straightforward connection which is also unobtrusive and convenient for a user.

In one embodiment, battery operated lighting system illustrated in FIG. 5 is a self-contained light unit, such as a flashlight. More specifically, lightbulb 30, switch 32, and battery 36 are all contained within a separate housing such as a cylindrical tube. This configuration should be recognized as a fairly well known flashlight structure. In practice, this separate housing is self-contained and sized to be easily molded into an upper portion of housing 22. To be effective the self-contained housing of the light system must be sized efficiently to be contained within housing 22 so that the plug housing 22 does not become unreasonably large.

As will be recognized, the plug-in end 20 illustrated in FIGS. 4 and 5 will easily allow a battery-operated light to be controlled by a user. Again, this could be incorporated into an extension cord as outlined above, or could be included in any appliance cord. This additional utility will allow any user to locate electrical receptacles when operating in dark environments or circumstances.

It will be appreciated that the battery 36 outlined above could be a standard battery, or could easily be rechargeable. Since line power will be present at certain times, there are certain advantages provided by a rechargeable battery. Further, the system could be configured so that the battery 36 is being recharged any time the cord is connected to electrical power. In this way, battery life becomes a very insignificant issue.

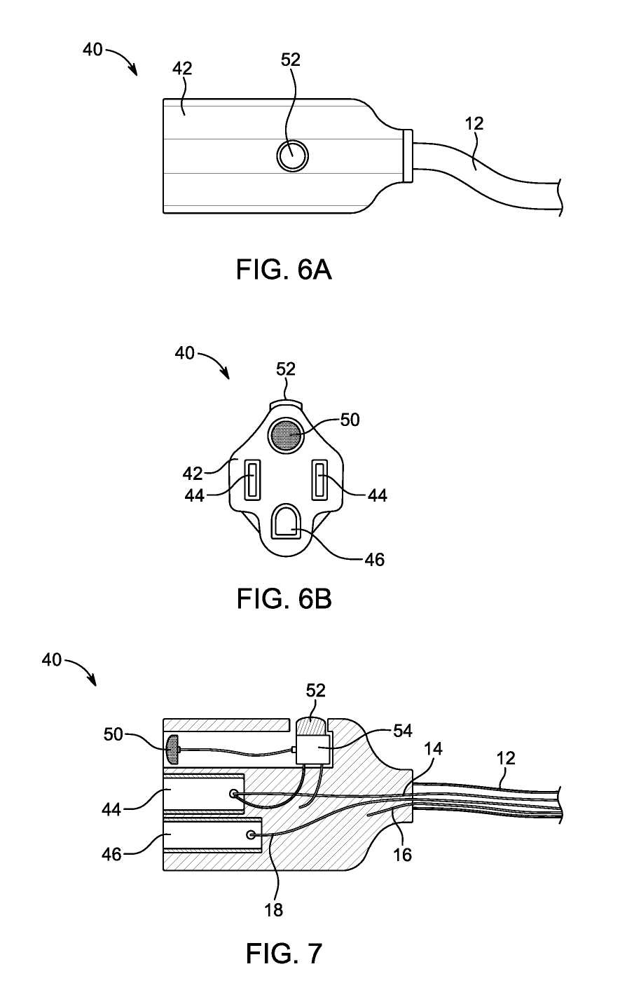

As generally discussed above, one embodiment of the present invention further includes a light source incorporated into the receptacle end 40 of an extension cord 10. Referring now to FIGS. 6A and 6B, the receptacle end 40 is better illustrated. Further, FIG. 7 illustrates a partial cross-sectional view, illustrating the internal components of receptacle end 40, as contemplated.

Referring now to FIGS. 6A and 6B, receptacle end 40 similarly includes a housing 42 which is designed to contain the components needed to provide electrical connections. Specifically, this will generally include a pair of power receptacles 44, and a ground receptacle 46. Contained within a front side of receptacle end 40 is a light source 50, which is operated by a push button switch 52 located on a top side of housing 42. Referring now specifically to FIG. 7, a cross-sectional schematic view is illustrated, which helps illustrate the inner workings of receptacle end 40. In this particular embodiment, bulb 50 is electrically connected to a switching mechanism 54. Switching mechanism 54 is operably connected to push button 52 to accommodate convenient user operation. As will be anticipated, ground receptacle 46 is similarly connected to an electrical cable 18. Power receptacle 44 is similarly connected to one of the required power cords 14 in order to provide necessary operation. Although not specifically illustrated in FIG. 7, a second electrical cord 16 will be operably connected to the other power receptacle 44. In receptacle end, electrical power is provided to switch 54 via internal electrical connections to the power supply lines. In this way, electrical power for light 50 is obtained only when the plug-in end 20 is connected to an electrical power source. This provides yet a further utility for the present invention, as the user is able to illuminate a work area or surroundings after electrical connections are obtained.

As a further enhancement, push button 52 is configured to have an embedded light device (such as a light emitting diode, or LED), which will be illuminated whenever power is present. In this way, a user will be able to easily see and locate button 52. Further, it is contemplated that button 52 is a click-on/click-off button which will allow the light to stay on for extended periods of time. Since this is driven by line power, the issues related to battery preservation do not exits.

In addition to the embodiments outlined above, another alternative may include the use of motion sensors to activate the relevant light source. In this embodiment, various types of motion sensors could be included in either the plug end housing or the receptacle end housing, which would then be used to activate or “wake” the cord when moved. The motion sensors could include an accelerometer which will detect movement of the cord end, or could include a hall-effect sensor which would detect the presence of other objects moving adjacent the relevant housing. Once movement is detected, a light within the housing would be activated. This could include the “spot light” itself, the light on the button, or an internal light to help find the cord end. In combination with the other features involved, this motion detection feature provides addition utility for the user.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. An extension cord having support lighting incorporated into the ends thereof, comprising:
an electrical cord having a plug-in end and a receptacle end;
a first housing affixed to the plug-in end of the electrical cord and supporting a set of prongs extending from the housing which provide a plug-in capability for the electrical system;
a second housing affixed at the receptacle end, the second housing supporting a receptacle capability of the electrical system, wherein the plug-in end and the receptacle end are electrically connected to one another;
a light system incorporated into the first housing, the light system having a light bulb, a battery configured to power the bulb, and a push button switch for selectively powering the light bulb, wherein the switch is located on an outer side of the housing and the light bulb is positioned to direct light out of the first housing in a direction of the extended prongs; and
wherein the second housing supports a second lighting system which comprises a second lighting system having a switch capable of selectively operating a second light bulb to direct light out of the second housing.

2. The electrical system of claim 1 wherein the switch is a push-and-hold switch located on an upper surface of the housing so the light system can be easily operated while a user is attempting to insert the prongs into a related receptacle.

3. The electrical system of claim 1 wherein the light bulb is an LED bulb.

4. The electrical system of claim 1 wherein the battery is rechargeable.

5. The electrical system of claim 1 wherein the end is a receptacle end configured to receive prongs.

6. The electrical system of claim 5 wherein the lighting system is further selectively connected to the electrical cord such that the bulb can be operated by electrical current being carried by the cord.

7. An electrical extension cord with support lighting, comprising:
An electrical cord having conductor wires configured to carry electrical current;
A first housing fixedly coupled to a first end of the electrical cord, the first housing supporting a set of electrical prongs configured to be coupled to an electrical receptacle, wherein the electrical prongs are electrically coupled to the conductor wires within the electrical cord, the first housing further supporting a light system comprising a bulb, a power source and a switch for selectively powering the bulb, wherein the bulb is aimed in a direction substantially parallel with a direction of the prongs; and
a second housing fixedly coupled to a second end of the electrical cord, the second housing supporting a receptacle structure configure to receive electrical prongs, the receptacle structure electrically coupled to the connector wires such that an electrical connection exists between the receptacle structure and the electrical prongs, the second housing further supporting a second lighting system having a bulb, a switch and a power connection, the power connection supplying power from the electrical cord to the switch so power from the cord can be selectively supplied to the bulb of the second lighting system, wherein the bulb of the second lighting system is aimed in a direction substantially parallel to a direction of the receptacle structure.

8. The electrical system of claim 7 wherein the power source of the first lighting system is a battery.

9. The electrical system of claim 8 wherein the switch of the first lighting system is a push-and-hold switch positioned on an upper surface of the housing so the light system can be easily operated while a user is attempting to insert the prongs into a related electrical outlet.

10. The electrical system of claim 7 wherein the switch of the second lighting system is positioned on an upper surface of the housing so the second light system can be easily operated while a user is holding the second housing.

11. The electrical system of claim 7 wherein the second housing also supports a second battery system so the second lighting system can be operated using power from the battery or power from the cord.

12. The electrical system of claim 7 wherein the prongs comprise three prongs including a positive, negative and ground prong.

13. The electrical system of claim 8 wherein the battery is rechargeable.
